(19) United States
(12) Patent Application Publication
(10) Pub. No.: US 2007/0029420 A1
(43) Pub. Date: Feb. 8, 2007

(54) Household and papershredder combination waste handler

(76) Inventors: Jonas V. Radstrom, Houston, TX (US); Emily G. Allen, Houston, TX (US)

Correspondence Address: OSHA LIANG L.L.P., 1221 MCKINNEY STREET, SUITE 2800, HOUSTON, TX, 77010, US

(21) Appl. No.: 11/371,470

(22) Filed: Mar. 9, 2006

Related U.S. Application Data
(60) Provisional application No. 60/705,729, filed on Aug. 5, 2005.

(51) Int. Cl. B02C 18/22

(52) U.S. Cl. 241/100; 241/236

(57) ABSTRACT

A combination waste handler is disclosed including a container for holding waste and defining an opening therein. A lid member is configured to mount on the container to at least partially cover the opening, the lid member defining a waste receiving portion and a shredding portion. A shredder is mounted in the shredding portion of the lid member such that the waste receiving portion allows passage of waste into the container without passing through the shredder. A cover is also disclosed for a combination waste handler having a container for holding waste and defining an opening therein. The cover includes a lid member configured to mount on the container to at least partially cover the opening, the lid member defining a waste receiving portion and a shredding portion; and a shredder mounted in the shredding portion of the lid member such that the waste receiving portion allows passage of waste into the container without passing through the shredder.

### CROSS-REFERENCE TO RELATED APPLICATIONS

This application claims priority, pursuant to 35 U.S.C. §119(e), of U.S. Provisional Application Ser. No. 60/705,729 filed on Aug. 5, 2005.

### BACKGROUND OF INVENTION

Modern household generates an incredible amount of waste paper ranging from children's homework to monthly utility bills and bank statements. Many of these papers contain personal information that are sensitive and private and can lead to identity theft crimes. According to the National Crime Prevention Council, identity theft has now become the fastest growing crime in the United States. In the year 2003, about 7 million people had their identity stolen and each spent on average $1,495 and 600 hours to straighten out the situation, not including lawyer's fees. The average amount stolen was $92,893. Add a home office and the likelihood of some private information falling into the wrong hands increases many fold.

To combat this growing information crime, President Bush has recently signed into law the Fair and Accurate Credit Transaction Act, which mandates the destruction of all paper or computer disks containing personal information derived from credit reports before discarding them. For instance, if a household member performs a credit check on a potential domestic employee before hiring him or her, it is now the law that this information must be destroyed before the paper or computer disk containing the information is discarded.

In practice, this law will pose a challenge to many households and home offices due to the lack of inexpensive, convenient and secure information destruction methods for households and home offices. Although personal shredders for handling sensitive waste papers can help in this effort and have been available for quite some time, currently available versions of paper shredders are still modelled after those used in corporate or industrial settings and are not easily integrated into the routine of daily household life. Personal shredders now available on the market are generally one of two types: integrated versions that have a dedicated wastebasket or standalone paper shredders that can be strapped over a standalone waste container. FIG. 1 shows an example of an integrated paper shredder having a dedicated wastebasket. The wastebasket 1 has a dimension exactly fitting the shredder 2, both of which are designed and manufactured as a single unit. To operate such a shredder, waste paper is fed through the shredder throat 3, shredded into strips and collected in the wastebasket. The wastebasket 1 may be transparent so that users can see the level of waste collected, or may have a small opening 4 for visual inspection of the content. This type of waste handlers usually are visually appealing but are limited to handle only wastes that can be shredded. They also have limited capacity and are tied to a specific size of basket.

FIG. 2 shows a typical standalone wastebasket 5 with an opening 6 having a dimension compatible with a standalone shredder 7. Waste paper is fed through the throat 8, shredded into strips 9, and dropped into the wastebasket 5. Such a waste handler, while more adaptable than an integrated shredder, is less visually appealing and more cumbersome to operate. Both types of shredders require the users to handle the shredded waste separately from other household wastes and do not lend themselves to be easily integrated into the regular routines of a household. In the case of an integrated shredder, the small opening 4 of the basket is merely for visual inspection of the basket content, and not suitable for receiving other household waste items. In the case of a standalone shredder/wastebasket setup, the shredder typically has to occupy a major portion of the wastebasket opening in order to keep the basket standing stably upright, thus, the wastebasket is also not suitable to be used for receiving other household waste items. Furthermore, in both of these prior art configurations, the shredded waste is still collected together in one place. This makes it easier for identity thieves to take the content of the wastebasket and reconstruct the shredded waste to obtain the sensitive information.

Therefore, there still exists a need for a new type of waste handling device and method that can be easily integrated into the environment and daily routines of a household to conveniently and securely destroy private information.

### SUMMARY OF INVENTION

One aspect of the invention relates to a combination waste handler. A combination waste handler in accordance with one embodiment of the invention has a container for holding waste, a lid member configured to mount on the container, and a shredder mounted in the lid member. The container has an opening that is covered at least partially by the lid member. The lid member defines a waste receiving portion and a shredding portion. The shredder is mounted in the shredding portion of the lid member such that waste may pass through the waste receiving portion of the lid member without passing through the thredder.

Another aspect of the invention relates to a cover for a combination waste handler having a container for holding waste. The container has an opening. The cover has a lid member configured to mount on the container to at least partially cover the opening. The lid member defines a waste receiving portion and a shredding portion where a shredder is to be mounted. The waste receiving portion of the lid member allows passage of waste into the container without passing through the shredder.

Other aspects and advantages of the invention will be apparent from the following description and the appended claims.

### BRIEF DESCRIPTION OF DRAWINGS

FIG. 1 shows a prior art paper shredder having an integrated wastebasket.

FIG. 2 shows a prior art standalone paper shredder together with a standalone wastebasket.

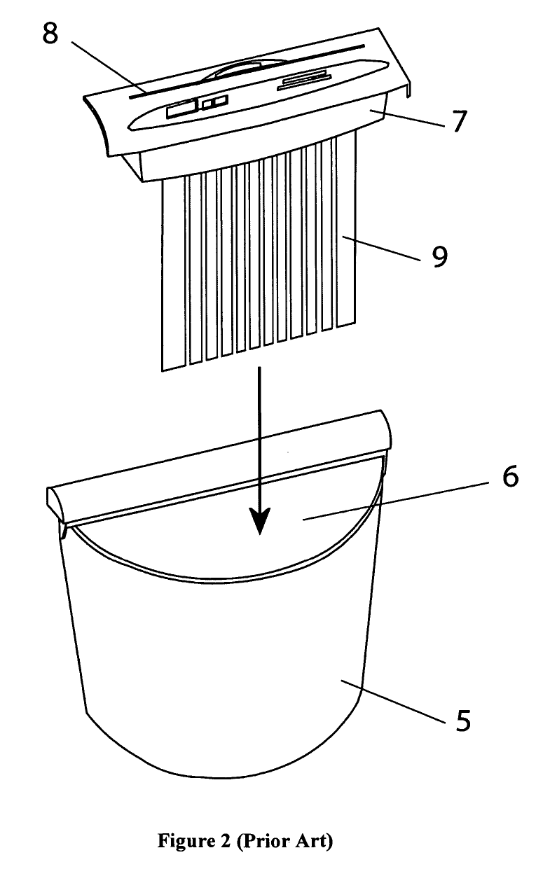

FIG. 3 shows a perspective view of a combination waste handler according to one embodiment of the present invention.

FIG. 4 shows a partial view of a combination waste handler according to one embodiment of the present invention having a single swinging door.

FIG. 5 shows a partial view of a combination waste handler according to one embodiment of the present invention having a double swinging door.

FIG. 6 shows a partial view of a combination waste handler according to one embodiment of the present invention having a side-mounted shredder.

FIG. 7 shows a perspective view of a lid member structure with an integrated shredder according to an embodiment of the present invention.

FIG. 8 shows a partial view of an embodiment of a combination waste handler according to the present invention having a shredder mounted on the side.

FIG. 9 shows a perspective view of a combination waste handler mounted on a kitchen cabinet according to one embodiment of the present invention.

### DETAILED DESCRIPTION

The present invention relates to a combination waste handler comprising a waste container and a shredder that forms an integral part of the container, a method of constructing a combination waste handler comprising an integrated shredder, and a method for conveniently and securely disposing of waste using a combination waste handler comprising an integrated shredder.

In the following, exemplary embodiments of the present invention will be discussed by referring to the accompanying figures. For the sake of clarity, similar features in different views of the figures will be referred to by the same reference numeral.

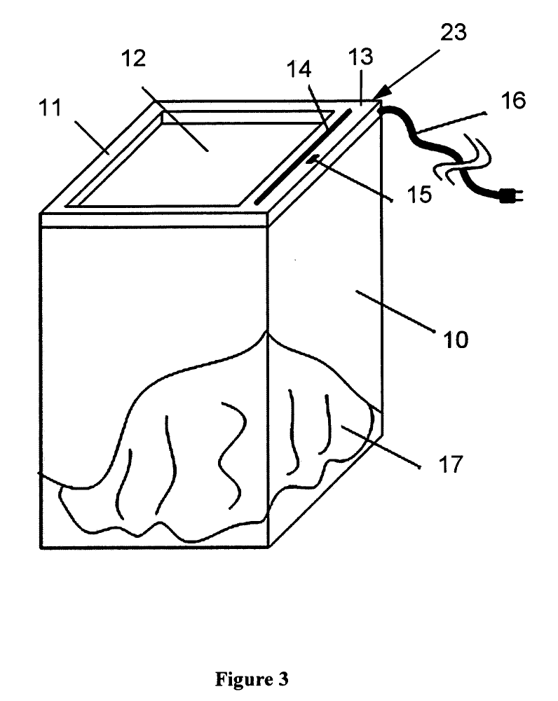

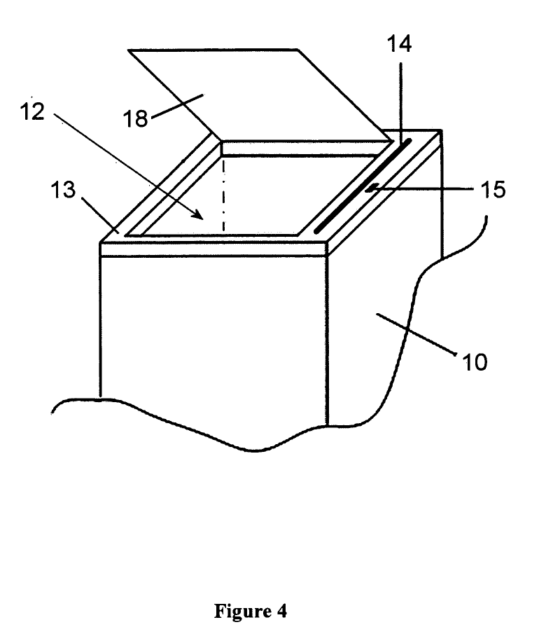

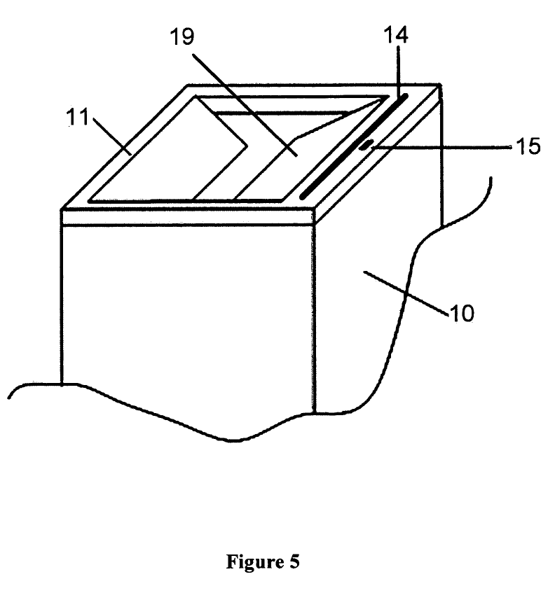

Referring first to FIG. 3, a combination shredder waste handler according to one embodiment of the invention has a container 10 and a lid member 11. The lid member 11 defines a waste receiving portion or opening 12 through which regular household waste items may be passed. The lid member 11 also defines a shredder portion 23 to which a shredder 13 is mounted. The shredder 13 may be formed integrally with the lid member 11, or may otherwise be permanently or removably mounted to the lid member 11. The shredder throat 14 is positioned near one side of the container as shown in FIG. 3 but may be placed in any position within the shredder portion of the lid member 11 without departing from the scope of the invention. The shredder controls 15 may be placed on the shredder itself or elsewhere on the lid member. The shredder may be either battery operated or may draw power directly from an electric outlet through a power cord 16. A disposable garbage bag 17 may additionally be fitted inside of the container. In some embodiments, the lid member opening 12 may have a door, in other embodiments, the lid member may not have a door. In those embodiments that have a lid door, the door can be a single swinging door 18 as shown in FIG. 4, a double swinging door 19 as shown in FIG. 5, or any other style of lid doors known in the art. The invention encompasses a combination waste handler including a container, a lid member and a shredder, as well as a cover for an existing container wherein the cover comprises a lid member and a shredder.

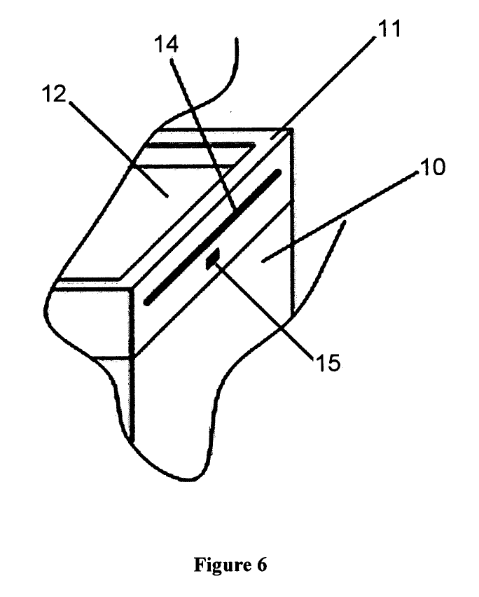

In the above exemplary embodiments, the shredder is shown as facing upward. However, a person skilled in the art would recognize that this is not a requirement. For example, in one embodiment, the shredder may be oriented such that the throat of the shredder 14 is on the same face as a sidewall of the container, as shown in FIG. 6. Other orientations may also be employed.

The shredder may use any type of shredding mechanism commonly known in the art, including strip-cut, cross-cut, or any other appropriate mechanism. The shredder preferably should be capable of shredding common information media including paper, plastic sheet, CD-ROM, DVD, computer disks, or any other information carrying media known in the art. Additionally, the shredder may have a variety of advanced functions including, but not limited to, automatic start/stop function by sensing the presence of an incoming waste item, reverse feed function, and automatic alarming of full basket by flashing a signal light, sounding an alarm, or any other commonly known signalling mechanism.

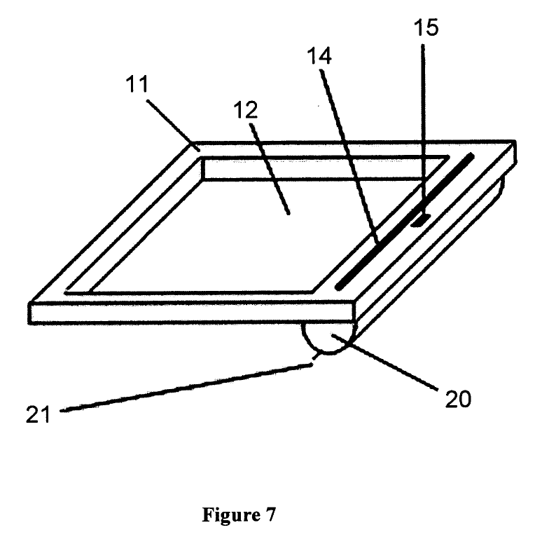

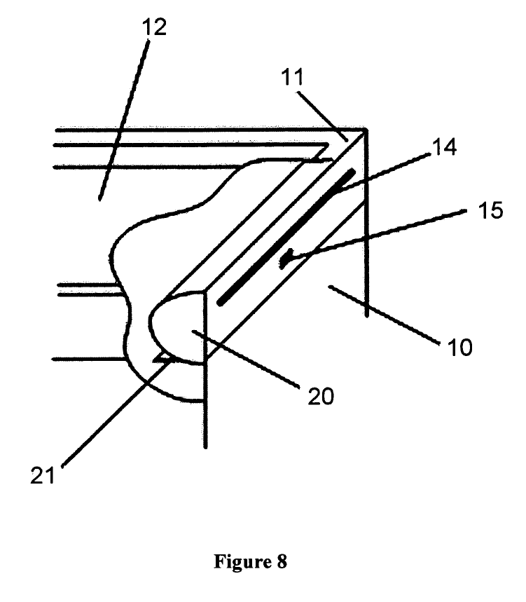

In some embodiments, the lid member may be a removable unit having an outer frame and an opening, and the shredder may be an integral part of the lid member, as shown in FIG. 7, where the throat of the shredder 14 is exposed on the surface of the lid member, and the body of the shredder 20 is on the underside of the lid member so that the exit guide 21 extends from the body of the shredder, leading into the waste container. Preferably, the shredder is positioned so that only the face containing the throat is exposed, and the body of the shredder 20 is on the side of the lid member facing the inside of the container, hidden away from external view, as shown in FIG. 8. When fitted over a container opening, the area of the container opening occupied by the shredder should be relatively small so that the opening is still large enough to accommodate regular household garbage items. A good range is about 60 percent of the container opening, preferably less than 40 percent, and most preferably less than 20%.

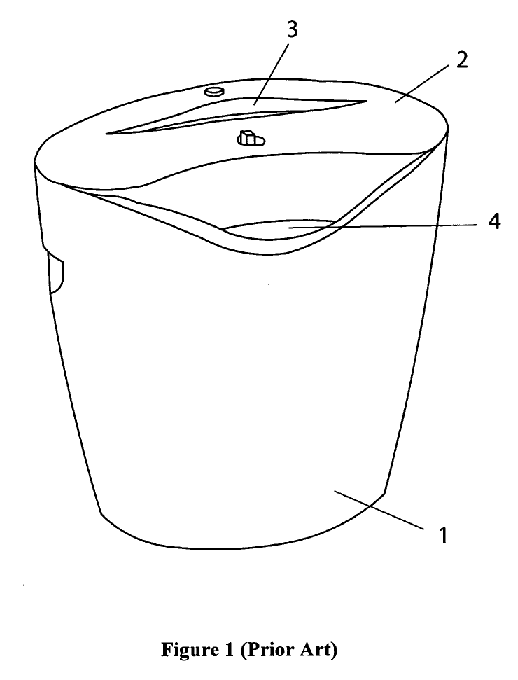

In some embodiments, the disposable garbage bag 17, as shown in FIG. 1, may be made of plastic, paper, canvas, or any other material known in the art. Preferably, the bag is one that is tough, secure, and environmentally friendly.

The container 10 may be any shape including rectangular tube, cubic, cylindrical, elliptical, or any other shape that is compatible with operation of the invention. The container can also be made of a variety of different types of materials including wood, plastic, stainless steel, aluminum alloy, or any other material commonly used in the art.

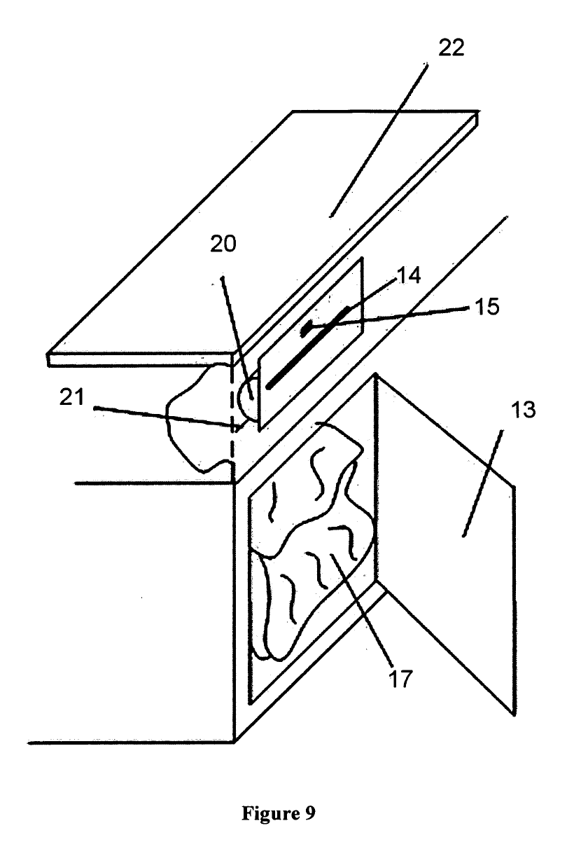

In some embodiments, a combination waste handler of the present invention may be integrated into a piece of household furniture such as a kitchen cabinet, a desk, etc. FIG. 9 shows an exemplary embodiment in which the waste handler forms an integral part of a kitchen cabinet 22 so that the lid member and the waste container form a part of the kitchen cabinet and the opening of the container is accessed through the lid door 13 (now also the cabinet door). The garbage bag 17 may have an opening adapted to receive only shredded waste items from the shredder, or may include a receptacle (not shown) for receiving regular household waste items through the opening that can be accessed via the lid door 13.

Referring again to FIG. 8, operation of a combination waste handler according to the invention begins by deciding whether a particular waste item is to be shredded. If the item is to be shredded, it is then fed through the throat 14 of the shredder. In cases where the shredder is an auto feed sensing shredder, the shredder is automatically activated by the incoming waste item. In cases where the shredder does not sense incoming feed automatically, the user would turn on the start/stop switch 15 first before feeding the waste item through the shredder. The shredded waste is then guided into the waste container by the exit guide 21. Examples of items to be shredded include bank statements, credit reports, ATM slips, transparencies, income tax papers, used floppy disks, CD-ROMs, etc. If an item is not to be shredded, it is then placed in the container through the lid member opening 12. Once a waste item is inside of the container, it becomes mixed with other previously deposited waste items.

Advantages of the various embodiments of the present invention include one or more of the following: A combination waste handler according to the present invention provides a container for receiving both shredded waste items and other non-shredded household waste items in one place, and an in-place shredder that affords convenient in-place shredding. Thus, such a combination waste handler does not require a user to alter his/her waste disposing routine by setting up a dedicated shredding waste handler. Because it can be integrated into existing furnishing around the household, it is visually unobtrusive, more convenient to use, and encourages consistent shredding habits from the users. Furthermore, by combining regular non-shredded household waste items with shredded waste items, the shredded items are further degraded and obscured, thereby making it much more difficult for a potential information thief to separate and reconstruct the shredded material, further enhancing the level of security achieved.

Although the present invention has been described in terms of specific exemplary embodiments, it will be appreciated that various modifications and alterations might be made by those skilled in the art without departing from the spirit and scope of the invention as set forth in the following claims.

What is claimed is:

1. A combination waste handler, comprising:
a container for holding waste, the container defining an opening therein;
a lid member configured to mount on the container to at least partially cover the opening, the lid member defining a waste receiving portion and a shredding portion; and
a shredder mounted in the shredding portion of the lid member;
wherein the waste receiving portion allows passage of waste into the container without passing through the shredder.

2. The combination waste handler according to claim 1, wherein the shredding portion covers no more than 60% of the opening of the container.

3. The combination waste handler according to claim 1, wherein the shredding portion covers no more than 40% of the opening of the container.

4. The combination waste handler according to claim 1, wherein the shredding portion covers no more than 20% of the opening of the container.

5. The combination waste handler according to claim 1, wherein the shredder comprises a body and a throat, and wherein the shredder is mounted in the shredding portion of the lid member such that the body faces the container and the throat faces outward.

6. The combination waste handler according to claim 1, wherein the shredder is formed integrally with the lid member.

7. The combination waste handler according to claim 1, further comprising a door mounted in the waste receiving portion of the lid member.

8. The combination waste handler according to claim 7, wherein the door is one selected from the group consisting of: a single swinging door, a double swinging door, a sliding door, and a revolving door.

9. The combination waste handler according to claim 1, wherein the shredder throat is positioned to face in the same direction as one sidewall of the container.

10. The combination waste handler according to claim 1, wherein the container forms an integral part of a household furnishing.

11. The combination waste handler according to claim 1, wherein the shredder comprises an automatic feed sensing function.

12. The combination waste handler according to claim 1, wherein the shredder comprises means for signaling the container is full.

13. A cover for a combination waste handler having a container for holding waste, the container defining an opening therein, the cover comprising:
a lid member configured to mount on the container to at least partially cover the opening, the lid member defining a waste receiving portion and a shredding portion; and
a shredder mounted in the shredding portion of the lid member;
wherein the waste receiving portion allows passage of waste into the container without passing through the shredder.

14. The cover according to claim 13, wherein the shredding portion covers no more than 60% of the opening of the container.

15. The cover according to claim 13, wherein the shredding portion covers no more than 40% of the opening of the container.

16. The cover according to claim 13, wherein the shredding portion covers no more than 20% of the opening of the container.

17. The cover according to claim 13, wherein the shredder comprises a body and a throat, and wherein the shredder is mounted in the shredding portion of the lid member such that the body faces the container and the throat faces outward.

18. The cover to claim 13, wherein the shredder is formed integrally with the lid member.

19. The cover according to claim 13, further comprising a door mounted in the waste receiving portion of the lid member.

20. The cover according to claim 13, wherein the container forms an integral part of a household furnishing.
